(19) United States
(12) Patent Application Publication
(10) Pub. No.: US 2020/0160431 A1
(43) Pub. Date: May 21, 2020

(54) ELECTRONIC DEVICE FOR PROVIDING AVATAR IMAGE ASSOCIATED WITH PAYMENT

(71) Applicant: SAMSUNG ELECTRONICS CO., LTD., Suwon-si (KR)

(72) Inventors: Hoon CHOI, Suwon-si (KR); Jemin LEE, Suwon-si (KR)

(21) Appl. No.: 16/690,421

(22) Filed: Nov. 21, 2019

(30) Foreign Application Priority Data
Nov. 21, 2018 (KR) 10-2018-0144363

(51) Int. Cl. G06Q 30/06; G06Q 20/32; G06Q 20/12; H04L 29/08

(52) U.S. Cl. CPC G06Q 30/0643; G06Q 20/3224; G06Q 20/3223; H04L 67/18; H04L 67/02; H04L 67/12; G06Q 20/123

(57) ABSTRACT

An electronic device may perform a payment process for a product of an offline store or an online store based on driving of a first application, obtain an image associated with the product based at least in part on payment information obtained by the performed payment process through a communication circuit, generate an item image corresponding to the product based at least in part on the obtained image, combine the item image with the avatar image, and display the composite avatar image on a display.

### CROSS-REFERENCE TO RELATED APPLICATION

This application is based on and claims priority under 35 U.S.C. § 119 to Korean Patent Application No. 10-2018-0144363, filed on Nov. 21, 2018, in the Korean Intellectual Property Office, the disclosure of which is incorporated by reference herein its entirety.

### BACKGROUND

### 1. Field

The disclosure relates to a technology for providing an avatar image of a user.

### 2. Description of Related Art

An electronic device may use information about an appearance of a user photographed through a camera to generate an avatar image of the user. The avatar image may be personalized for the user. For example, the avatar image may be modified by a separate editing program.

The electronic device may provide the avatar image obtained by combining various item images or background images. The various item images and background images may be applied depending on a taste of the user.

An item image and a background image may be provided in an electronic device in advance or may be images provided by an external server. Therefore, a user's selection may be limited to images set to be provided in advance.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address at least the above-mentioned problems and/or disadvantages and to provide at least the advantages described below. Accordingly, an example aspect of the disclosure is to provide an electronic device capable of providing various item images or background images using payment information associated with a payment performed by the electronic device.

In accordance with an example aspect of the disclosure, an electronic device includes a housing, a communication circuit disposed inside the housing, a touch screen display viewable through a part of the housing, at least one processor disposed inside the housing and operatively connected to the communication circuit and the touch screen display, and a memory disposed inside the housing and operatively connected to the at least one processor, wherein the memory may be configured to store a first application for performing a payment at an offline store or an online store and an avatar image, and wherein the memory may store instructions that, when executed, cause the at least one processor to control the electronic device to: perform a payment process for a product of the offline store or the online store based on driving of the first application, obtain an image associated with the product based at least in part on payment information obtained by the performed payment process through the communication circuit, generate an item image corresponding to the product based at least in part on the obtained image, combine the item image with the avatar image, and display the composite avatar image on the display.

In accordance with another example aspect of the disclosure, an electronic device includes a housing, a touch screen display viewable through a part of the housing, a communication circuit disposed inside the housing, a processor disposed inside the housing and operatively connected to the display and the communication circuit, and a memory operatively connected to the processor, wherein the memory may be configured to store an avatar image, and wherein the memory may store instructions that, when executed, cause the processor to control the electronic device to: receive payment information of a product using the communication circuit from an external server, obtain at least one identification information of the product based at least in part on the received payment information, obtain a universal resource locator (URL) associated with the product included in the payment information to analyze a web page connected to the URL, generate an image of an avatar item associated with the product based at least in part on the obtained identification information and the analyzed result, and combine the stored avatar image with the generated image of the avatar item to provide the composite image on the display.

Other aspects, advantages, and salient features of the disclosure will become apparent to those skilled in the art from the following detailed description, which, taken in conjunction with the annexed drawings, discloses various example embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of illustrating an example electronic device according to an embodiment;

FIG. 2 is a diagram illustrating an example operation environment of an electronic device according to an embodiment;

FIG. 3 is a diagram illustrating an example operation of generating an avatar image by an electronic device according to an embodiment;

FIG. 4 is a flowchart illustrating an example method of generating an item image for a product to be paid according to an embodiment;

FIG. 5 is diagram illustrating an example of a screen for generating an item image of a product to be paid according to an embodiment;

FIG. 6 is a flowchart illustrating an example method of generating an item image for a product to be paid according to various embodiments;

FIG. 7 is a diagram illustrating an example of a screen for downloading an item image according to an embodiment;

FIG. 8 is a flowchart illustrating an example method of generating an item image for a product to be paid according to various embodiments;

FIG. 9 is a signal flow diagram illustrating an example method of generating an item image for a product to be paid according to various embodiments;

FIG. 10 is a signal flow diagram illustrating an example method of obtaining an item image provided depending on location information in various embodiments;

FIG. 11 is a diagram illustrating an example of a screen including a tag associated with an item image in various embodiments; and

FIG. 12 is a block diagram illustrating an example electronic device in a network environment according to various embodiments.

In description of the drawings, the same or similar reference numerals may be used for the same or similar components.

### DETAILED DESCRIPTION

Hereinafter, various example embodiments of the disclosure may be described with reference to accompanying drawings. Accordingly, those of ordinary skill in the art will understand that various modifications, equivalents, and/or alternatives on the various example embodiments described herein may be variously made without departing from the scope and spirit of the disclosure.

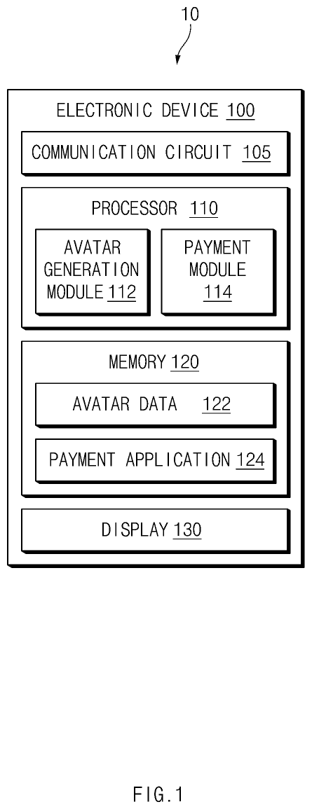

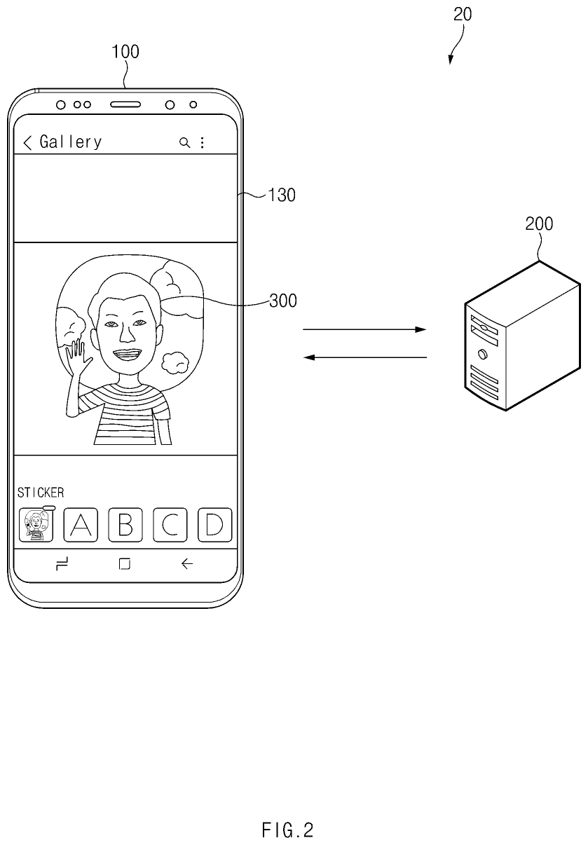

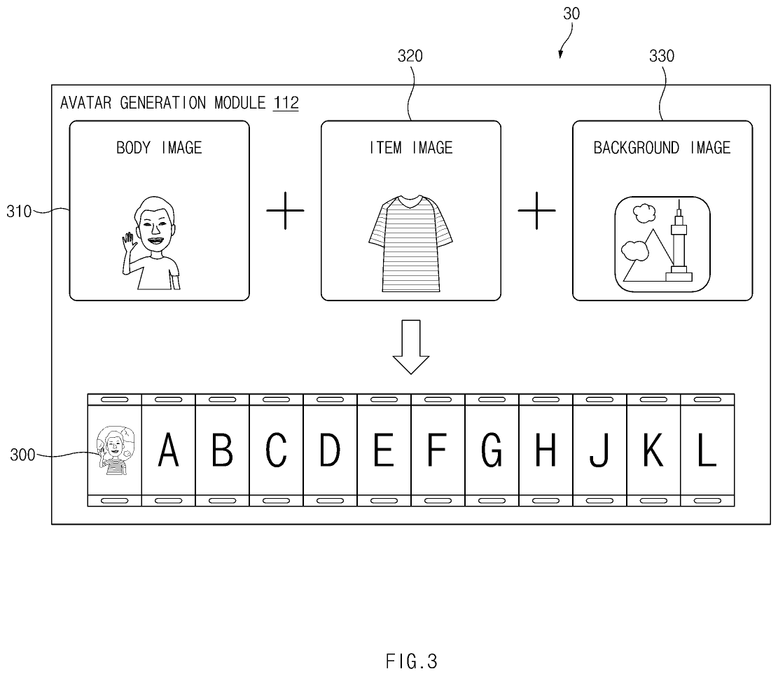

FIG. 1 is a block diagram 10 of illustrating an example electronic device 100 according to an embodiment. FIG. 2 is a diagram illustrating an example operation environment 20 of the electronic device 100 according to an embodiment. FIG. 3 is a diagram 30 illustrating an example operation of generating an avatar image 300 by the electronic device 100 according to an embodiment.

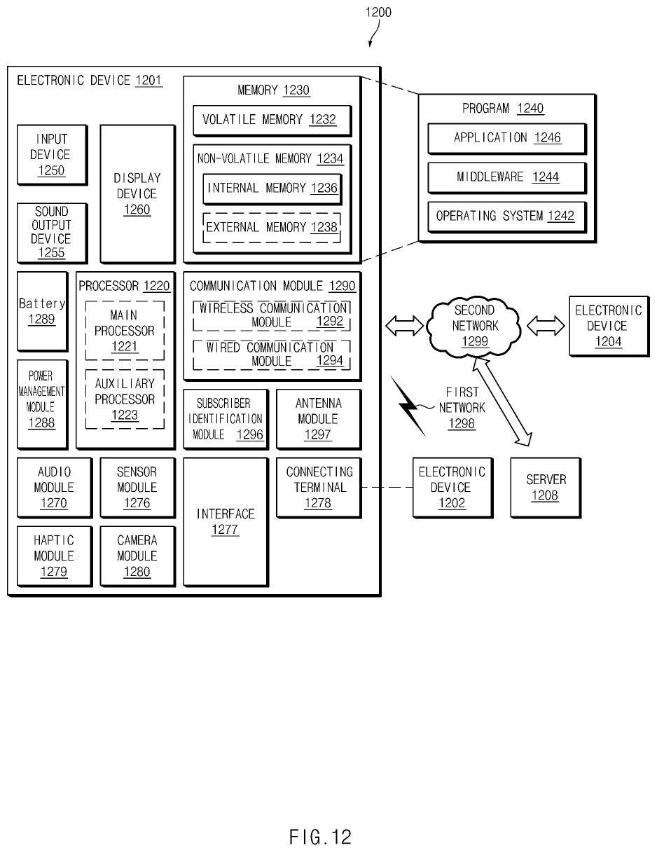

Referring to FIG. 1, the electronic device 100 according to an embodiment may include a communication circuit 105, a processor (e.g., including processing circuitry) 110, a memory 120, and a display 130. According to another embodiment, the electronic device 100 may further include at least one of components included in an electronic device 1201 of FIG. 12 in addition to the components shown in FIG. 1.

According to an embodiment, the electronic device 100 may transmit/receive data with an external device (e.g., an external server 200) through the communication circuit 105. The external device or the external server 200 may include at least one of a server of an offline store, a server of an online store, a server associated with a payment application, or a server of a card company. For example, the electronic device 100 may receive payment information from the external server 200 through the communication circuit 105.

According to an embodiment, the processor 110 may include various processing circuitry including modules comprising processing circuitry and/or executable program elements, such as, for example, and without limitation, an avatar generation module 112 and a payment module 114. In an embodiment, the processor 110 may execute instructions stored in the memory 120 to drive the avatar generation module 112 and the payment module 114. Various modules mentioned in various embodiments of the disclosure may be implemented in hardware or in software or in a combination thereof. In various embodiments of the disclosure, operations performed by the avatar generation module 112 and the payment module 114 may be understood as operations performed by the processor 110. In addition, an operation described as being performed by the electronic device 100 may be understood as an operation performed by the processor 110.

The memory 120 of the electronic device 100 may store an avatar data 122 and a payment application 124. The avatar generation module 112 may use the avatar data 122 stored in the memory 120 to generate an avatar image. The electronic device 100 may display the avatar image on the display 130.

The electronic device 100 may proceed with a payment process by driving the payment application 124 stored in the memory 120. For example, the payment module 114 may perform operations generated by driving the payment application 124. The payment application 124 (e.g., a mobile pay application) may include instructions to perform a payment for the offline store and online store. The offline store which may include various stores (e.g., a restaurant and a store) may be understood as a store having a payment terminal (e.g., a point of sale (POS), a card payment terminal). The electronic device 100 may proceed with the payment process by communicating with the payment terminal of the offline store. The online store may be understood as a store which sells the product online through a web browser or an application. The electronic device 100 may proceed with the payment process by communicating with a payment interface provided by the online store. Hereinafter, an object that a user of the electronic device 100 wants to purchase and pays at the offline store or online store may be represented as a product of the offline store or online store (hereinafter, referred to as a store).

Referring to FIG. 2, the electronic device 100 may display the avatar image 300 on the display 130. The avatar image 300 may, for example, be an image file and may be displayed as a still image. An avatar image where a plurality of image files are combined may be displayed.

Referring to FIG. 3, the avatar image 300 may include a body image 310, an item image 320 (e.g., an avatar item image), and a background image 330. The avatar data 122 stored in the memory 120 may include the body image 310, the item image 320, the background image 330, and the avatar image 300 combining the above-described three images. According to an embodiment, at least one of the body image 310, the item image 320, the background image 330, or the avatar image 300 may, for example, and without limitation, be a two-dimensional image or a three-dimensional image. According to an embodiment, at least one of the body image 310, the item image 320, the background image 330, or the avatar image 300 may be a static image (e.g., a still image) or a dynamic image to which an animation effect is applied.

According to an embodiment, the body image 310 may be an image of a face and a body personalized to each user. The body image 310 may be understood as an image representing, for example, and without limitation, a shape of the face, a shape of the body, and an expression of the face. The item image 320 (e.g., the avatar item image) may, for example, and without limitation, be an image of an item wearable on the face or body included in the body image 310. For example, item image 320 may be clothes or accessories. In an embodiment, the item image 320 may correspond to the product of the store. The background image 330 may, for example, and without limitation, be a shape like a city, a mountain, or an image pattern. For example, a place where the electronic device 100 is currently located may be displayed as the background image 330.

For example, the electronic device 100 may perform the payment process for a specific product and obtain the payment information from the external server 200 based on the payment process. The payment information may include, for example, and without limitation, at least one of a uniform resource locator (URL) including an image associated with the product, a payment amount, a name of the product, a name of the store, or information of a card on which the payment process is performed. The electronic device 100 may obtain the item image 320 corresponding to the specific product using the payment information. For example, when the item image 320 is a T-shirt, the electronic device 100 may combine the T-shirt with the body image 310 and display the composite avatar image 300 on the display 130.

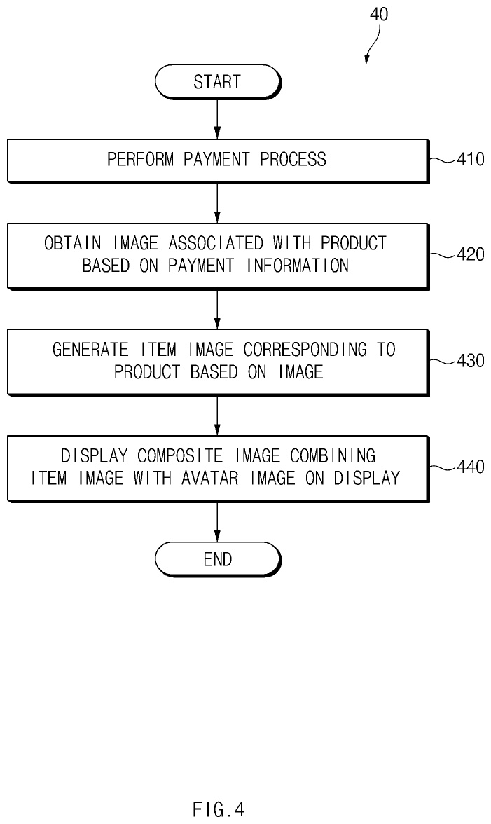

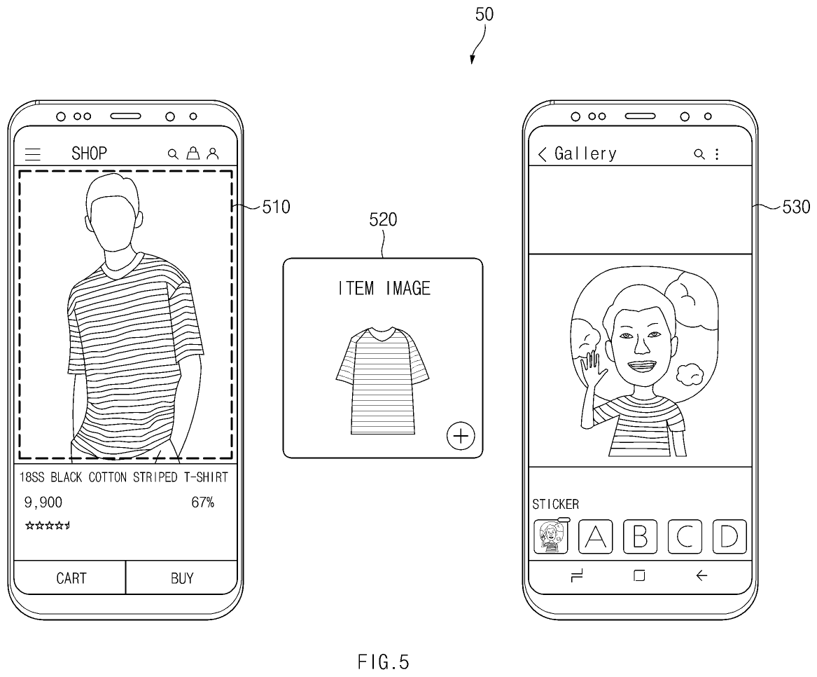

FIG. 4 is a flowchart 40 illustrating an example method of generating an item image for a product to be paid according to an embodiment. FIG. 5 is a diagram 50 illustrating an example of a screen for generating an item image of a product to be paid according to an embodiment.

Referring to FIG. 4, operation 410, 420, 430 and operation 440 (which may be referred to hereinafter as operation(s) 410 to 440) may be performed by, for example, the electronic device 100 illustrated in FIG. 1. For example, each of operation 410 to operation 440 may be implemented as instructions which are performed (or executed) by the processor 110 to control the electronic device 100. The instructions may be stored in, for example, a computer recording medium or the memory 120 of the electronic device 100 shown in FIG. 1. Hereinafter, the description of operation 410 to operation 440 that is the same as described with reference to FIG. 1 may not be repeated here.

In operation 410, the electronic device 100 may, for example, perform the payment process for the product of the offline store or online store based on the driving of the payment application 124. For example, referring to FIG. 5, a screen on which the T-shirt is sold in the online store may be displayed on the display 130 of the electronic device 100. The screen may include an image 510 associated with the T-shirt. For example, operation 410 may refer to a situation in which the payment process for the T-shirt is performed.

In operation 420, the electronic device 100 may obtain an image associated with the product based at least at least in part on the payment information obtained by the payment process. Referring to FIG. 5, the electronic device 100 may obtain the image 510 associated with the T-shirt.

For example, the electronic device 100 may obtain the URL including the image 510 associated with the product included in the payment information to obtain the image 510 associated with the product through the URL. The URL may include an address on a web browser which includes the image 510 associated with the product of the online store. For example, the electronic device 100 may access the URL and download the image 510 associated with the product.

In operation 430, the electronic device 100 may generate an item image 520 (e.g., the item image 320 of FIG. 3) corresponding to the product based on the image 510 associated with the product.

In operation 440, the electronic device 100 may display the avatar image 300 combined with the item image 320 using the avatar data 122 on the display 130. For example, referring to FIG. 5, the electronic device 100 may generate the item image 520 (e.g., the item image 320 of FIG. 3) based on the image 510 associated with the product. The electronic device 100 may analyze the image 510 associated with the product and generate an image similar to the product included in the image 510 associated with the product as the item image 520. For example, the image analysis operation may be performed by an external server (e.g., 200 of FIG. 2, an avatar item generating server, or a separate external server). In this example, the electronic device 100 may transmit the acquired image 510 associated with the product to the external server and the external server may analyze the image 510 associated with the product to generate the item image similar to the product. The electronic device 100 may receive the item image generated from the external server. The electronic device 100 may display an avatar image 530 (e.g., the avatar image 300 of FIG. 3) combined with the item image 520, on the display (e.g., the display 130 of FIG. 1).

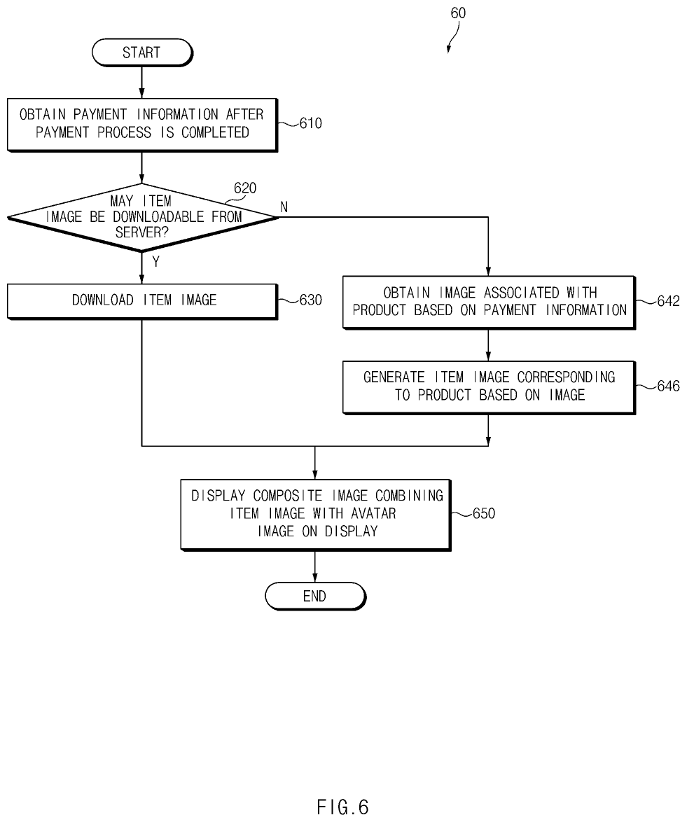

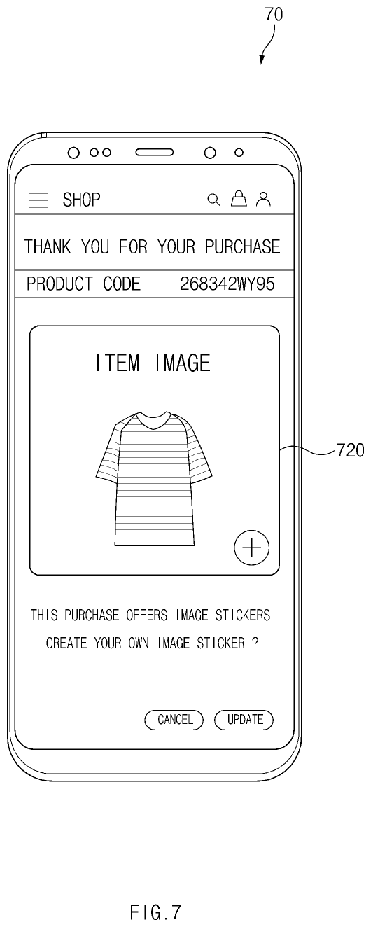

FIG. 6 is a flowchart 60 illustrating an example method of generating an item image for a product to be paid according to various embodiments. FIG. 7 is a diagram 70 illustrating an example of a screen for downloading an item image according to an embodiment.

In operation 610, the electronic device 100 may obtain the payment information after the payment process is completed. According to an embodiment, the electronic device 100 may obtain the payment information from the external server 200. In this example, the external server 200 may be at least one of a server of an offline store, a server of an online store, a server associated with a payment application, or a server of a card company.

For example, when the payment process is completed, the electronic device 100 may receive a push message or a text message from the external server 200. The payment information included in the push message or the text message may include at least one of a URL including an image associated with the product, a payment amount, a name of the product, a name of the store, and information of a card on which the payment process is performed.

In operation 620, the electronic device 100 may determine whether an item image (e.g., the item image 520 of FIG. 5) may be downloaded from the external server 200. For example, when the external server 200 is the server of the offline or online store, the external server 200 may selectively provide the item image for the product. When the external server 200 provides the item image, the electronic device 100 may download the item image from the external server 200 (“Yes” in operation 620) in operation 630 without using the payment information. For example, referring to FIG. 7, the electronic device 100 may display a screen indicating that an item image 720 (e.g., the item image 320 of FIG. 3 or the item image 520 of FIG. 5) is capable of being downloaded after the payment process is completed. When a user input for downloading the item image 720 is received, the electronic device 100 may download the item image 720 from the external server 200, and in operation 650, a composite image combining the item image with the avatar image (e.g., the avatar image 300 of FIG. 3 or the avatar image 530 of FIG. 5) may be displayed on the display.

When the external server 200 does not provide the item image (“No” in operation 620), in operation 642 and operation 646, the electronic device 100 may obtain the image associated with the product based on the payment information and generate the item image from the obtained image. Operation 642 and operation 646 may correspond to operation 420 and operation 430 of FIG. 4, respectively.

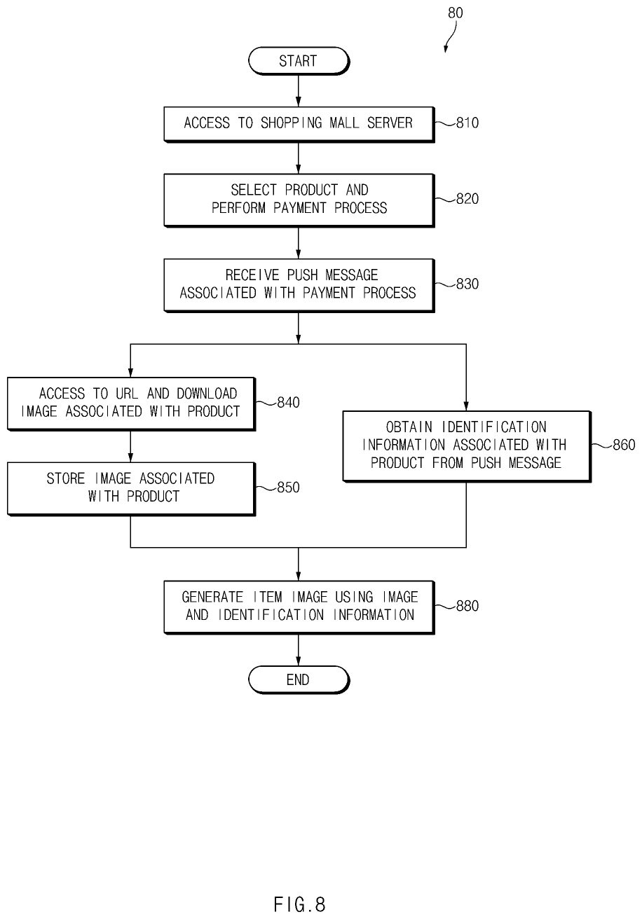

FIG. 8 is a flowchart 80 illustrating an example method of generating an item image for a product to be paid according to various embodiments.

In operation 810, for example, the electronic device 100 may connect to a shopping mall server (or a server of an online store) (e.g., the external server 200), select the product in operation 820, and perform the payment process for the product. In some embodiments, when the payment process is performed, the electronic device 100 may receive the payment information.

In operation 830, the electronic device 100 may receive a push message associated with the payment process. For example, the push message may include a payment request message, a payment approval message, and a payment cancellation message. For example, the push message may include identification information associated with the product. In various embodiments, the push message may be received from the external server 200 (e.g., a payment server) which operates in conjunction with the payment application 124. According to an embodiment, the electronic device 100 may separately receive the push message and the payment information or may receive the payment information through the push message.

In operation 840, the electronic device 100 may download an image (e.g., the image 510 associated with the product of FIG. 5) associated with the product using the URL included in the payment information. In operation 850, the electronic device 100 may store the downloaded image in the memory 120.

In operation 860, the electronic device 100 may obtain the identification information associated with the product from the push message. For example, the identification information may include a name of the product and a type of the product.

In operation 880, the electronic device 100 may generate an item image (e.g., the item image 320 of FIG. 3, the item image 520 of FIG. 5, or the item image 720 of FIG. 7) using the stored image and the obtained identification information. The electronic device 100 may map the generated item image onto the identification information to store the generated item image in the avatar data 122 of the memory 120. In various embodiments, the identification information may include a product image (e.g., the image 510 associated with the product of FIG. 5). The electronic device 100 may generate an item image using the product image included in the payment information.

According to various embodiments, when the payment information does not include the URL, the electronic device 100 may search for an image similar to the product using the identification information included in the payment information. For example, when the type of the product is a smartphone and the name of the product is Galaxy, the electronic device 100 may search for Galaxy smartphone through the web browser and download an image included in a search result as the product image.

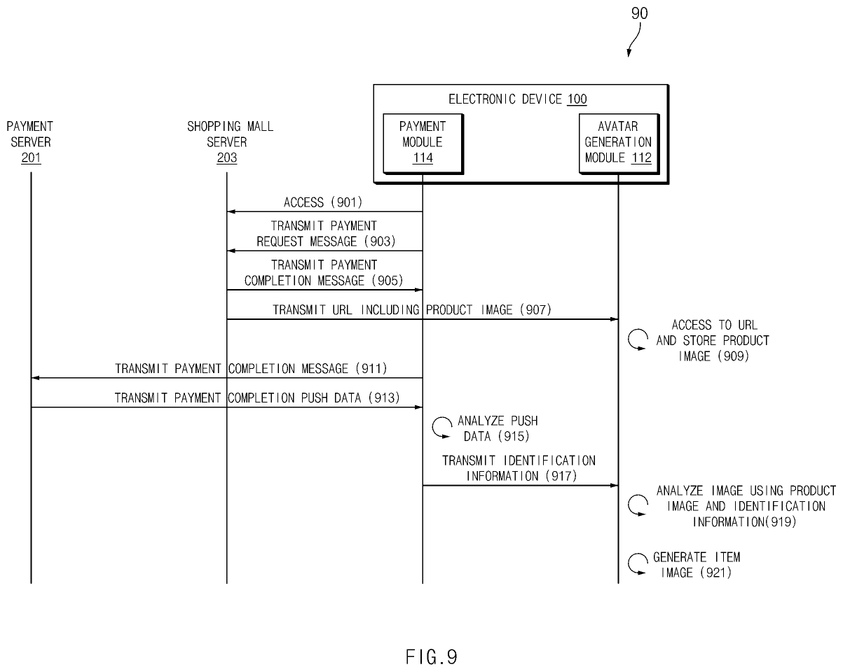

FIG. 9 is a signal flow diagram 90 illustrating an example method of generating an item image for a product to be paid according to various embodiments.

In various embodiments, the electronic device 100 may communicate with two or more external servers (e.g., the external server 200 of FIG. 2). For example, the electronic device 100 may access to a shopping mall server 203 (e.g., the server of the offline or online store) in operation 901. The payment module 114 of the electronic device 100 may transmit a payment request message to the shopping mall server 203 to perform the payment on the shopping mall server 203 in operation 903. The payment request message may include user personal information such as a credit card number and a password for performing the payment. The shopping mall server 203 may perform the payment using information included in the payment request message and transmit a payment completion message in operation 905.

According to various embodiments, the shopping mall server 203 may transmit a URL including a product image (e.g., the image 510 associated with the product of FIG. 5) to the electronic device 100 in operation 907. The avatar generation module 112 of the electronic device 100 may access to the URL, download and store the product image in operation 909.

The payment module 114 of the electronic device 100 may transmit the payment completion message to a payment server 201 (e.g., a server associated with a payment application) which operates in conjunction with the payment application 124 in operation 911. The payment server 201 may transmit the payment completion push message to the payment module 114 in operation 913. According to an embodiment, the payment completion push message may be generated from a server (e.g., a server of a card company) separate from the shopping mall server 203 and the payment server 201. The payment module 114 of the electronic device 100 may analyze the received push message in operation 915 and extract the identification information associated with the product from the push message. The payment module 114 may transmit the extracted identification information (e.g., the name of the product and the type of the product) to the avatar generation module 112 in operation 917.

The avatar generation module 112 may analyze the product image using the product image and the identification information. For example, referring to FIG. 5, the image 510 associated with the product may further include a model wearing the product and a background in addition to the product. When the identification information is ‘T-shirt’ or ‘clothes’, the avatar generation module 112 may recognize that an object to be extracted from the image 510 associated with the product is an image about clothes and T-shirt. Accordingly, the avatar generation module 112 may distinguish a portion associated with the product from the image 510 associated with the product based on the identification information and generate the item image 520 similar to the distinguished portion in operation 921.

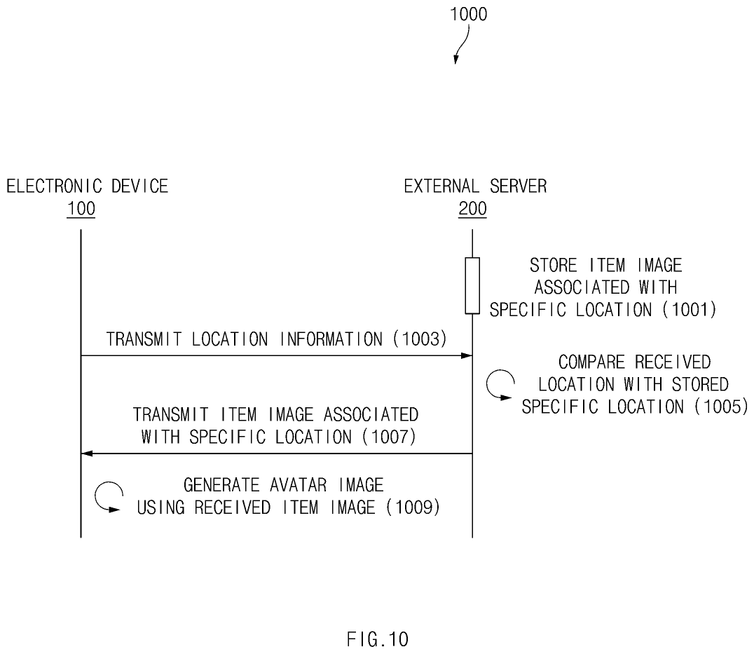

FIG. 10 is a signal flow diagram 1000 illustrating an example method of obtaining an item image provided depending on location information in various embodiments.

According to various embodiments, an item image (e.g., the item image 320 of FIG. 3, the item image 520 of FIG. 5, or the item image 720 of FIG. 7) or a background image (e.g., the background image 330 of FIG. 3) depending on a location of the electronic device 100 may be provided. The electronic device 100 may include a location sensor (e.g., a GPS). Hereinafter, an example in which the item image is provided is described. For example, the external server 200 providing the item image may store the item image associated with a specific location in operation 1001.

The electronic device 100 may obtain location information using the location sensor. The electronic device 100 may transmit current location information to the external server 200 in operation 1003. The external server 200 may compare the received location information with previously stored specific location information in operation 1005. When the received location is included in a previously stored specific location range, the external server 200 may transmit an item image corresponding to the previously stored specific location information to the electronic device 100 in operation 1007. The electronic device 100 may generate an avatar image (e.g., the avatar image 300 of FIG. 3 or the avatar image 530 of FIG. 5) using the received item image in operation 1009.

According to various embodiments of the disclosure, when a specific product is purchased using the electronic device 100 in the specific location range, an item image associated with the purchased product may be provided. For example, a specific item image may be provided based on both the location information of the electronic device 100 and the payment information. For example, when the electronic device 100 is located at a location of an amusement park ‘A’ and a payment information for purchasing a character doll as a specific product of the amusement park ‘A’ is obtained, the item image associated with the character doll may be provided to the electronic device 100.

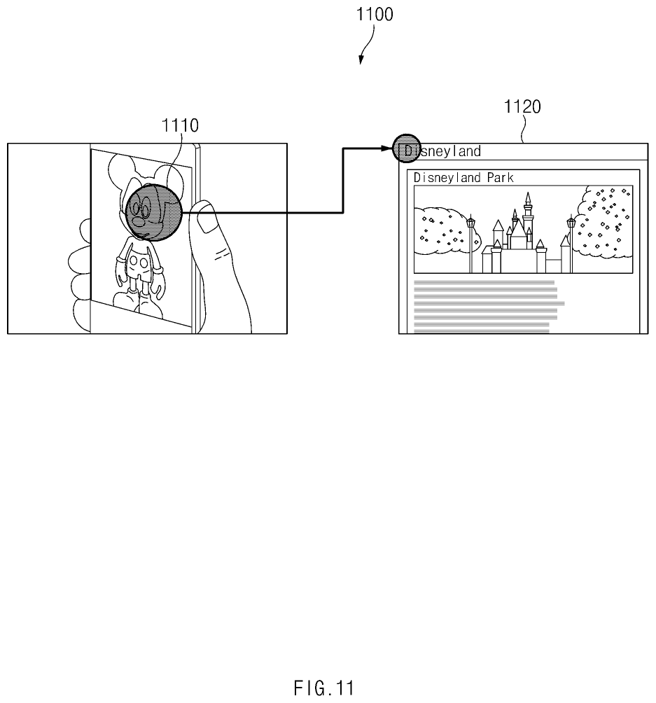

FIG. 11 is a diagram 1100 illustrating an example of a screen including a tag associated with an item image in various embodiments.

In various embodiments, the electronic device 100 may generate an avatar image including a tag associated with an item image and/or a background image. Referring to FIG. 11, a character is illustrated as an item image 1110. The item image 1110 may include a URL associated with the character as tag information. When the electronic device 100 receives a selection input (e.g., touch or click) for the tag, the electronic device 100 may access to a homepage 1120 associated with the character using the URL included in the tag.

For example, the tag may be displayed in an area associated with the item image on a composite avatar image.

In various embodiments, when receiving the selection input for the item image 1110, the electronic device 100 may be configured to request information associated with the item image 1110 from the external server 200 (e.g., a seller server). In this example, the electronic device 100 may receive information related to the item image 1110 from the external server 200. The information related to the item image 1110 may include information of a product corresponding to the item image 1110. The electronic device 100 may display the received information on the display 130.

FIG. 12 is a block diagram illustrating an example electronic device 1201 in a network environment 1200 according to various embodiments. Referring to FIG. 12, the electronic device 1201 may communicate with an electronic device 1202 through a first network 1298 (e.g., a short-range wireless communication network) or may communicate with an electronic device 1204 or a server 1208 through a second network 1299 (e.g., a long-distance wireless communication network) in a network environment 1200. According to an embodiment, the electronic device 1201 may communicate with the electronic device 1204 through the server 1208. According to an embodiment, the electronic device 1201 may include a processor 1220, a memory 1230, an input device 1250, a sound output device 1255, a display device 1260, an audio module 1270, a sensor module 1276, an interface 1277, a haptic module 1279, a camera module 1280, a power management module 1288, a battery 1289, a communication module 1290, a subscriber identification module 1296, or an antenna module 1297. According to some embodiments, at least one (e.g., the display device 1260 or the camera module 1280) among components of the electronic device 1201 may be omitted or one or more other components may be added to the electronic device 1201. According to some embodiments, some of the above components may be implemented with one integrated circuit. For example, the sensor module 1276 (e.g., a fingerprint sensor, an iris sensor, or an illuminance sensor) may be embedded in the display device 1260 (e.g., a display).

The processor 1220 may execute, for example, software (e.g., a program 1240) to control at least one of other components (e.g., a hardware or software component) of the electronic device 1201 connected to the processor 1220 and may process or compute a variety of data. According to an embodiment, as a part of data processing or operation, the processor 1220 may load a command set or data, which is received from other components (e.g., the sensor module 1276 or the communication module 1290), into a volatile memory 1232, may process the command or data loaded into the volatile memory 1232, and may store result data into a nonvolatile memory 1234. According to an embodiment, the processor 1220 may include a main processor 1221 (e.g., a central processing unit or an application processor) and an auxiliary processor 1223 (e.g., a graphic processing device, an image signal processor, a sensor hub processor, or a communication processor), which operates independently from the main processor 1221 or with the main processor 1221. Additionally or alternatively, the auxiliary processor 1223 may use less power than the main processor 1221, or is specified to a designated function. The auxiliary processor 1223 may be implemented separately from the main processor 1221 or as a part thereof.

The auxiliary processor 1223 may control, for example, at least some of functions or states associated with at least one component (e.g., the display device 1260, the sensor module 1276, or the communication module 1290) among the components of the electronic device 1201 instead of the main processor 1221 while the main processor 1221 is in an inactive (e.g., sleep) state or together with the main processor 1221 while the main processor 1221 is in an active (e.g., an application execution) state. According to an embodiment, the auxiliary processor 1223 (e.g., the image signal processor or the communication processor) may be implemented as a part of another component (e.g., the camera module 1280 or the communication module 1290) that is functionally related to the auxiliary processor 1223.

The memory 1230 may store a variety of data used by at least one component (e.g., the processor 1220 or the sensor module 1276) of the electronic device 1201. For example, data may include software (e.g., the program 1240) and input data or output data with respect to commands associated with the software. The memory 1230 may include the volatile memory 1232 or the nonvolatile memory 1234.

The program 1240 may be stored in the memory 1230 as software and may include, for example, an operating system 1242, a middleware 1244, or an application 1246.

The input device 1250 may receive a command or data, which is used for a component (e.g., the processor 1220) of the electronic device 1201, from an outside (e.g., a user) of the electronic device 1201. The input device 1250 may include, for example, a microphone, a mouse, a keyboard, or a digital pen (e.g., a stylus pen).

The sound output device 1255 may output a sound signal to the outside of the electronic device 1201. The sound output device 1255 may include, for example, a speaker or a receiver. The speaker may be used for general purposes, such as multimedia play or recordings play, and the receiver may be used for receiving calls. According to an embodiment, the receiver and the speaker may be either integrally or separately implemented.

The display device 1260 may visually provide information to the outside (e.g., the user) of the electronic device 1201. For example, the display device 1260 may include a display, a hologram device, or a projector and a control circuit for controlling a corresponding device. According to an embodiment, the display device 1260 may include a touch circuitry configured to sense the touch or a sensor circuit (e.g., a pressure sensor) for measuring an intensity of pressure on the touch.

The audio module 1270 may convert a sound and an electrical signal in dual directions. According to an embodiment, the audio module 1270 may obtain the sound through the input device 1250 or may output the sound through the sound output device 1255 or an external electronic device (e.g., the electronic device 1202 (e.g., a speaker or a headphone)) directly or wirelessly connected to the electronic device 1201.

The sensor module 1276 may generate an electrical signal or a data value corresponding to an operating state (e.g., power or temperature) inside or an environmental state (e.g., a user state) outside the electronic device 1201. According to an embodiment, the sensor module 1276 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 1277 may support one or more designated protocols to allow the electronic device 1201 to connect directly or wirelessly to the external electronic device (e.g., the electronic device 1202). According to an embodiment, the interface 1277 may include, for example, an HDMI (high-definition multimedia interface), a USB (universal serial bus) interface, an SD card interface, or an audio interface.

A connecting terminal 1278 may include a connector that physically connects the electronic device 1201 to the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal to a mechanical stimulation (e.g., vibration or movement) or an electrical stimulation perceived by the user through tactile or kinesthetic sensations. According to an embodiment, the haptic module 1279 may include, for example, a motor, a piezoelectric element, or an electric stimulator.

The camera module 1280 may shoot a still image or a video image. According to an embodiment, the camera module 1280 may include, for example, at least one or more lenses, image sensors, image signal processors, or flashes.

The power management module 1288 may manage power supplied to the electronic device 1201. According to an embodiment, the power management module 1288 may be implemented as at least a part of a power management integrated circuit (PMIC).

The battery 1289 may supply power to at least one component of the electronic device 1201. According to an embodiment, the battery 1289 may include, for example, a non-rechargeable (primary) battery, a rechargeable (secondary) battery, or a fuel cell.

The communication module 1290 may establish a direct (e.g., wired) or wireless communication channel between the electronic device 1201 and the external electronic device (e.g., the electronic device 1202, the electronic device 1204, or the server 1208) and support communication execution through the established communication channel. The communication module 1290 may include at least one communication processor operating independently from the processor 1220 (e.g., the application processor) and supporting the direct (e.g., wired) communication or the wireless communication. According to an embodiment, the communication module 1290 may include a wireless communication module 1292 (e.g., a cellular communication module, a short-range wireless communication module, or a GNSS (global navigation satellite system) communication module) or a wired communication module 1294 (e.g., an LAN (local area network) communication module or a power line communication module). The corresponding communication module among the above communication modules may communicate with the external electronic device through the first network 1298 (e.g., the short-range communication network such as a Bluetooth, a WiFi direct, or an IrDA (infrared data association)) or the second network 1299 (e.g., the long-distance wireless communication network such as a cellular network, an internet, or a computer network (e.g., LAN or WAN)). The above-mentioned various communication modules may be implemented into one component (e.g., a single chip) or into separate components (e.g., chips), respectively. The wireless communication module 1292 may identify and authenticate the electronic device 1201 using user information (e.g., international mobile subscriber identity (IMSI)) stored in the subscriber identification module 1296 in the communication network, such as the first network 1298 or the second network 1299.

The antenna module 1297 may transmit or receive a signal or power to or from the outside (e.g., an external electronic device). According to an embodiment, the antenna module may include one antenna including a radiator formed of a conductor or a conductive pattern formed on a substrate (e.g., a PCB). According to an embodiment, the antenna module 1297 may include a plurality of antennas. In this case, for example, the communication module 1290 may select one antenna suitable for a communication method used in the communication network such as the first network 1298 or the second network 1299 from the plurality of antennas. The signal or power may be transmitted or received between the communication module 1290 and the external electronic device through the selected one antenna. According to some embodiments, components other than radiators (e.g., RFIC) may be further formed as a part of the antenna module 1297.

At least some components among the components may be connected to each other through a communication method (e.g., a bus, a GPIO (general purpose input and output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 1201 and the external electronic device 1204 through the server 1208 connected to the second network 1299. Each of the electronic devices 1202 and 1204 may be the same or different types as or from the electronic device 1201. According to an embodiment, all or some of the operations performed by the electronic device 1201 may be performed by one or more external electronic devices among the external electronic devices 1202, 1204, or 1208. For example, when the electronic device 1201 performs some functions or services automatically or by request from a user or another device, the electronic device 1201 may request one or more external electronic devices to perform at least some of the functions related to the functions or services, in addition to or instead of performing the functions or services by itself. The one or more external electronic devices receiving the request may carry out at least a part of the requested function or service or the additional function or service associated with the request and transmit the execution result to the electronic device 1201. The electronic device 1201 may provide the result as is or after additional processing as at least a part of the response to the request. To this end, for example, a cloud computing, distributed computing, or client-server computing technology may be used.

As described above, an electronic device (e.g., 100 of FIG. 1) includes a housing (not shown), a communication circuit (e.g., 105 of FIG. 1) disposed inside the housing, a touch screen display (e.g., 130 of FIG. 1) viewable through a part of the housing, at least one processor (e.g., 110 of FIG. 1) disposed inside the housing and operatively connected to the communication circuit and the touch screen display, and a memory (e.g., 120 of FIG. 1) disposed inside the housing and operatively connected to the at least one processor, wherein the memory may be configured to store a first application for performing a payment for an offline store or an online store and an avatar image, and wherein the memory may be configured to store instructions that, when executed, cause the at least one processor to control the electronic device to: perform a payment process for a product of the offline store or the online store based on driving of the first application, obtain an image associated with the product based at least in part on payment information obtained by the performed payment process through the communication circuit, generate an item image corresponding to the product based at least in part on the obtained image, combine the item image with the avatar image, and display the composite avatar image on the display.

According to an example embodiment, the instructions may, when executed, cause the processor to control the electronic device to: obtain a URL associated with the image associated with the product included in the payment information, and obtain the image associated with the product through the URL.

According to an example embodiment, the URL may include an address for the image of the product.

According to an example embodiment, the instructions may, when executed, cause the processor to control the electronic device to: obtain and generate the item image based on the identification information and the image.

According to an example embodiment, the instructions may, when executed, cause the processor to control the electronic device to: analyze the image based at least in part on the identification information and generate the item image based at least in part on the analyzed result.

According to an example embodiment, the identification information may include a name of the product and a type of the product

According to an example embodiment, the instructions may, when executed, cause the processor to control the electronic device to: receive a message including the payment information through the communication circuit from an external sever operating in conjunction with the first application.

According to an example embodiment, the payment information may include at least one of a name of the offline store or online store, a name of the product, and a URL including the image of the product.

According to an example embodiment, the instructions may, when executed, cause the processor to control the electronic device to: receive the message based on the payment process being completed.

According to an example embodiment, the instructions may, when executed, cause the processor to control the electronic device to: store the generated item image in the memory.

According to an example embodiment, the instructions may, when executed, cause the processor to control the electronic device to: map the generated item image onto the identification information to store the item image in the memory.

According to an example embodiment, the electronic device may further include a location sensor, wherein the instructions may, when executed, cause the processor to control the electronic device to: obtain location information of the electronic device using the location sensor, transmit the location information to an external server using the communication circuit, and obtain the item image corresponding to the location information from the external server using the communication circuit.

According to an example embodiment, the instructions may, when executed, cause the processor to control the electronic device to: display the avatar image combining the generated item image with the item image corresponding to the location information on the display.

According to an example embodiment, the instructions may, when executed, cause the processor to control the electronic device to: display a tag associated with the product in an area associated with the item image of the composite avatar image on the display.

As described above, an electronic device (e.g., 100 of FIG. 1) includes a housing (not shown), a touch screen display (e.g., 130 of FIG. 1) viewable through a part of the housing, a communication circuit (e.g., 105 of FIG. 1) disposed inside the housing, a processor (e.g., 110 of FIG. 1) disposed inside the housing and operatively connected to the display and the communication circuit, and a memory (e.g., 120 of FIG. 1) operatively connected to the processor, wherein the memory may be configured to store an avatar image, and wherein, when instructions stored in the memory are executed, the processor may control the electronic device to: receive payment information of a product using the communication circuit from an external server, obtain at least one identification information of the product based at least in part on the received payment information, obtain a universal resource locator (URL) associated with the product included in the payment information to analyze a web page connected to the URL, generate an image of an avatar item associated with the product based at least in part on the obtained identification information and the analyzed result, and combine the stored avatar image with the generated image of the avatar item to provide the composite image on the display.

According to an example embodiment, the identification information may include at least one of product seller information, a name of the product, image information of the product, or type information of the product.

According to an example embodiment, the instructions may, when executed, cause the processor to control the electronic device to: map the generated avatar item onto the obtained at least one of identification information to store the generated avatar item at a database (DB) of the memory.

According to an example embodiment, the instructions may, when executed, cause the processor to control the electronic device to: transmit the received payment information to an avatar item generation server using the communication circuit, receive an avatar item generated by the avatar item generation server based at least in part on the received payment information using the communication circuit, and combine the received avatar item with the stored avatar image.

According to an example embodiment, the electronic device may further include a location sensor, wherein the instructions may, when executed, cause the processor to control the electronic device to: obtain location information using the location sensor and generate the image of the avatar item based at least in part on the obtained location information and the payment information.

According to an example embodiment, the instructions may, when executed, cause the processor to control the electronic device to: receive an input for selecting the generated avatar item, request product information corresponding to the avatar item from a product seller server in response to the received input using the communication circuit, receive the product information from the product seller server, and provide the received product information on the display.

According to example embodiments disclosed in the disclosure, the various item images or background images based on the payment may be provided. The avatar image may be combined in various forms.

Besides, a variety of effects directly or indirectly understood through the disclosure may be provided.

The electronic device according to various embodiments disclosed in the disclosure may be various types of devices. The electronic device may include, for example, a portable communication device (e.g., a smartphone), a computer device, a portable multimedia device, a mobile medical appliance, a camera, a wearable device, a home appliance, or the like. The electronic device according to an embodiment of the disclosure should not be limited to the above-mentioned devices.

It should be understood that various embodiments of the disclosure and terms used in the embodiments do not intend to limit technical features disclosed in the disclosure to the particular embodiment disclosed herein; rather, the disclosure should be understood to cover various modifications, equivalents, or alternatives of embodiments of the disclosure. With regard to description of drawings, similar or related components may be assigned with similar reference numerals. As used herein, singular forms of noun corresponding to an item may include one or more items unless the context clearly indicates otherwise. In the disclosure disclosed herein, each of the expressions “A or B”, “at least one of A and B”, “at least one of A or B”, “A, B, or C”, “one or more of A, B, and C”, or “one or more of A, B, or C”, and the like used herein may include any and all combinations of one or more of the associated listed items. The expressions, such as “a first”, “a second”, “the first”, or “the second”, may be used merely for the purpose of distinguishing a component from the other components, but do not limit the corresponding components in other aspect (e.g., the importance or the order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

The term “module” used in the disclosure may include a unit implemented in hardware, software, or firmware, or any combination thereof, and may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, according to an embodiment, the “module” may include an application-specific integrated circuit (ASIC).

Various embodiments of the disclosure may be implemented by software (e.g., the program 1240) including an instruction stored in a machine-readable storage medium (e.g., an internal memory 1236 or an external memory 1238) readable by a machine (e.g., the electronic device 1201). For example, the processor (e.g., the processor 1220) of a machine (e.g., the electronic device 1201) may call the instruction from the machine-readable storage medium and execute the instructions thus called. This may refer, for example, to the machine performing at least one function based on the called at least one instruction. The one or more instructions may include a code generated by a compiler or a code executable by an interpreter. The machine-readable storage medium may be provided in the form of non-transitory storage medium. Here, the “non-transitory”, storage medium is tangible, but may not include a signal (e.g., an electromagnetic wave). The term “non-transitory” does not differentiate a case where the data is permanently stored in the storage medium from a case where the data is temporally stored in the storage medium.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be directly distributed (e.g., download or upload) online through an application store (e.g., a Play Store™) or between two user devices (e.g., the smartphones). In the case of online distribution, at least a portion of the computer program product may be temporarily stored or generated in a machine-readable storage medium such as a memory of a manufacturer's server, an application store's server, or a relay server.

According to various embodiments, each component (e.g., the module or the program) of the above-described components may include one or plural entities. According to various embodiments, at least one or more components of the above components or operations may be omitted, or one or more components or operations may be added. Alternatively or additionally, some components (e.g., the module or the program) may be integrated in one component. In this case, the integrated component may perform the same or similar functions performed by each corresponding components prior to the integration. According to various embodiments, operations performed by a module, a programming, or other components may be executed sequentially, in parallel, repeatedly, or in a heuristic method, or at least some operations may be executed in different sequences, omitted, or other operations may be added.

While the disclosure has been illustrated and described with reference to various example embodiments thereof, it will be understood by those skilled in the art that various changes in form and details may be made therein without departing from the spirit and scope of the disclosure as set forth, for example, in the appended claims and their equivalents.

What is claimed is:

1. An electronic device comprising:
a housing;
a communication circuit disposed inside the housing;
a touch screen display viewable through a part of the housing;
at least one processor disposed inside the housing and operatively connected to the communication circuit and the touch screen display; and
a memory disposed inside the housing and operatively connected to the at least one processor,
wherein the memory is configured to store a first application for performing a payment for an offline store or an online store and an avatar image, and
wherein the memory is configured to store instructions that, when executed, cause the at least one processor to control the electronic device to:
perform a payment process for a product of the offline store or the online store based on driving of the first application,
obtain an image associated with the product based at least in part on payment information obtained by the performed payment process through the communication circuit,
generate an item image corresponding to the product based at least in part on the obtained image,
combine the item image with the avatar image, and
display the composite avatar image on the display.

2. The electronic device of claim 1, wherein the instructions, when executed, cause the processor to control the electronic device to:
obtain a URL associated with the image associated with the product included in the payment information, and
obtain the image corresponding to the product through the URL.

3. The electronic device of claim 2, wherein the URL includes an address for the image corresponding to the product.

4. The electronic device of claim 1, wherein the instructions, when executed, cause the processor to control the electronic device to:
obtain identification information associated with the product included in the payment information, and
generate the item image based on the identification information and the image.

5. The electronic device of claim 4, wherein the instructions, when executed, cause the processor to control the electronic device to:
analyze the image based at least in part on the identification information, and
generate the item image based at least in part on the analyzed result.

6. The electronic device of claim 4, wherein the identification information includes a name of the product and a type of the product.

7. The electronic device of claim 1, wherein the instructions, when executed, cause the processor to control the electronic device to: receive a message including the payment information through the communication circuit from an external sever operating in conjunction with the first application.

8. The electronic device of claim 7, wherein the payment information includes at least one of a name of the offline store or online store, a name of the product, and a URL including the image of the product.

9. The electronic device of claim 7, wherein the instructions, when executed, cause the processor to control the electronic device to: receive the message based on the payment process being completed.

10. The electronic device of claim 1, wherein the instructions, when executed, cause the processor to control the electronic device to store the generated item image in the memory.

11. The electronic device of claim 4, wherein the instructions, when executed, cause the processor to control the electronic device to: map the generated item image onto the identification information to store the item image in the memory.

12. The electronic device of claim 1, further comprising:
a location sensor,
wherein the instructions, when executed, cause the processor to control the electronic device to:
obtain location information of the electronic device using the location sensor,
transmit the location information to an external server using the communication circuit, and
obtain the item image corresponding to the location information from the external server using the communication circuit.

13. The electronic device of claim 12, wherein the instructions, when executed, cause the processor to control the electronic device to: display the avatar image combining the generated item image with the item image corresponding to the location information on the display.

14. The electronic device of claim 1, wherein the instructions, when executed, cause the processor to control the electronic device to: display a tag associated with the product in an area associated with the item image of the composite avatar image on the display.

15. An electronic device comprising:
a housing;
a touch screen display viewable through a part of the housing;
a communication circuit disposed inside the housing;
a processor disposed inside the housing and operatively connected to the display and the communication circuit; and
a memory operatively connected to the processor,
wherein the memory is configured to store an avatar image, and
wherein the memory is configured to store instructions that, when executed, cause the processor to control the electronic device to:
receive payment information of a product using the communication circuit from an external server,
obtain at least one identification information of the product based at least in part on the received payment information,
obtain a universal resource locator (URL) associated with the product included in the payment information to analyze a web page connected to the URL,
generate an image of an avatar item associated with the product based at least in part on the obtained identification information and the analyzed result, and
combine the stored avatar image with the generated image of the avatar item to provide the composite image on the display.

16. The electronic device of claim 15, wherein the identification information includes at least one of product seller information, a name of the product, image information of the product, or type information of the product.

17. The electronic device of claim 15, wherein the instructions, when executed, cause the processor to control the electronic device to: map the generated avatar item onto the obtained at least one obtained identification information to store the generated avatar item at a database of the memory.

18. The electronic device of claim 15, wherein the instructions, when executed, cause the processor to control the electronic device to:
transmit the received payment information to an avatar item generation server using the communication circuit,
receive an avatar item generated by the avatar item generation server based at least in part on the received payment information using the communication circuit, and
combine the received avatar item with the stored avatar image.

19. The electronic device of claim 15, further comprising:
a location sensor,
wherein the instructions, when executed, cause the processor to control the electronic device to: obtain location information using the location sensor and generate the image of the avatar item based at least in part on the obtained location information and the payment information.

20. The electronic device of claim 15, wherein the instructions, when executed, cause the processor to control the electronic device to:
receive an input for selecting the generated avatar item,
request product information corresponding to the avatar item from a product seller server, in response to the received input using the communication circuit,
receive the product information from the product seller server, and
provide the received product information on the display.
